(19) United States
(12) Patent Application Publication
(10) Pub. No.: US 2014/0271286 A1
(43) Pub. Date: Sep. 18, 2014

(54) Noise Producing Fan

(71) Applicant: William McNeill, Winterville, NC (US)

(72) Inventor: William McNeill, Winterville, NC (US)

(21) Appl. No.: 14/146,144

(22) Filed: Jan. 2, 2014

Related U.S. Application Data
(60) Provisional application No. 61/781,149, filed on Mar. 14, 2013.

(51) Int. Cl. G10K 15/04; F04D 25/06

(52) U.S. Cl. CPC G10K 15/04; F04D 25/06
USPC 417/423.1

(57) ABSTRACT

A noise producing fan with low air movement or variable air movement is provided. The device comprises a conventional mechanical fan that is adapted to provide a soothing and steady volume of ambient noise for a user to block out background noise and sleep comfortably. The mechanical fan includes several embodiments, including different fan blade arrangements, means of interchanging fan blades on the mechanical fan hub, different fan shrouds that allow for access to the fan hub, and finally an imbalanced fan hub that creates an oscillatory motion to increase noise production. The fan blades for low air movement and efficient noise generation are flat or perforated, and secure to the fan hub as it oscillates and rotates within the mechanical fan housing.

### CROSS REFERENCE TO RELATED APPLICATION

This application claims the benefit of U.S. Provisional Application No. 61/781,149 filed on Mar. 14, 2013, entitled “Windless, Noise-Producing Fan.” The above identified patent application is herein incorporated by reference in its entirety to provide continuity of disclosure.

### BACKGROUND OF THE INVENTION

1. Field of the Invention

The present invention relates to mechanical fans for personal use and those utilized for noise creation while sleeping. More specifically, the present invention pertains to a mechanical fan sleeping aid that is adapted to create a volume of noise emanating therefrom while having a reduced or modifiable air flow rate from its movement fan blades. The goal of the present invention is to provide a device that creates spectrum-level noise for use in all weather conditions, wherein the fan can be tailored for minimal air movement with maximum noise generation to drown out sounds for a sleeping user.

Many individuals require a specific environment for comfortable sleep. Many enjoy complete darkness and no noise, while others require ambient noise as a sleep aid. These types of sleeping users employ different means for generating a background noise, including electronic white noise generators, a television set at a given volume, and further mechanical fans that generate air flow and fan noise. While the latter is the most convenient method for creating a broad spectrum level of noise, mechanical fans also generate air flow in the room, which may or may not be desirable for the sleeping user.

For those individuals in colder climates or during colder periods of the year, a mechanical fan generating interior air flow may not be desirable. The convective air flow will quickly chill the user in the night, which for some is highly undesirable. To prevent such occurrences, individuals may turn down the speed of the fan, which causes a reduction in noise generated therefrom and thus its effectiveness as a sleeping aid. Therefore for these users, what is required is a device that allows one to tailor the air flow emanating from a mechanical fan while maintaining a high level of noise production. Alternatives may include white noise generators and use of television sets as sleeping aids, however these are not as soothing as fan noise and may not suit those particularly accustomed to the soothing sound of a fan while sleeping.

The present invention pertains to a new and novel mechanical fan that is adapted to act as a noise generator, and operably supply a flow of air to the user if desired. The fan includes an electric motor and fan blade assembly, wherein the fan blades are preferably inefficient air flow generators (e.g. flat blades) and the fan blade assembly is imbalanced with respect to its rotation. The slight imbalance generates a noise, while the fan blades themselves generate noise when moving through the air. Their inherent inefficiency reduces the amount of air flow therefrom, wherein the air is not effectively moved in one direction as it would be using traditionally curved fan blades. Several embodiments are contemplated for the fan blades and their ability to be interchanged within the fan housing, wherein the user can tailor the assembly as desired for the purposes of noise generation and operation as an air flow means.

2. Description of the Prior Art

Devices have been disclosed in the prior art that relate to mechanical fans, noise generators, and sleeping aids. These include devices that have been patented and published in patent application publications, and generally relate to electronic noise generator devices, those mechanical fans that are adapted for improved air flow efficiency, and sleeping aids having little to do with mechanical fans.

Traditional fan blades for a mechanical fan are rotating vanes having a defined curvature, wherein the blades are adapted to create a high volume movement of air therefrom. The movement of air cools a user by way of evaporative cooling and convection, whereby the air movement facilitates heat being drawn away from the body and reduced stagnate, humid air close to the user's skin. While this type of device is highly desirable for those in warmer climates or those that have high body temperatures, for those sleeping users in milder to colder climates, such an assembly can quickly chill a user and make the user uncomfortable.

The present invention is differentiated from the art in that it provides a mechanical fan whose primary purpose is not air movement, but rather noise generation. A first embodiment contemplates a fan blade assembly having a defined structure comprising flat fan blades, those with apertures therethrough, or those that comprise smaller surface areas. A second embodiment contemplates a modular assembly that allows the user to open the fan housing and replace the fan blades with those with different air movement efficiency. This second embodiment allows the user to customize the amount of air flow emanating from the device throughout the year and over different seasons where different air movement requirements may be desired. Finally, the electric motor utilized to drive the fan blade assembly and the fan blade assembly itself are disposed in an imbalanced configuration, wherein the imbalance creates a reciprocating noise generation in and of itself during operation.

It is submitted that the present invention is substantially divergent in design elements from the prior art, and consequently it is clear that there is a need in the art for an improvement to existing noise generation devices. In this regard the instant invention substantially fulfills these needs.

### SUMMARY OF THE INVENTION

In view of the foregoing disadvantages inherent in the known types of noise generating devices now present in the prior art, the present invention provides a new mechanical fan assembly that can be utilized for providing convenience for the user when generating a broad spectrum noise source for sleeping, while having reduced or operably controlled air movement.

It is therefore an object of the present invention to provide a new and improved noise generating device that has all of the advantages of the prior art and none of the disadvantages.

It is another object of the present invention to provide a noise generating fan assembly that provides a variable level of noise production and an operably low quantity of air movement while in operation, wherein the noise production and the amount of air movement generated can be tailored by the user.

Another object of the present invention is to provide a noise generating fan assembly that utilizes flat or inefficient fan blades to generate noise while reducing their capacity to generate air flow through the mechanical fan housing.

Yet another object of the present invention is to provide a noise generating fan assembly that provides a fan housing that can be opened to provide access to the fan hub for the user, whereby the fan blades may be changed to suit the user's air flow needs over different seasons.

Another object of the present invention is to provide a noise generating fan assembly that functions as a noise generator without an electronic noise generation means, whereby the assembly can further be tailored for use as a traditional, high air flow mechanical fan if desired.

A final object of the present invention is to provide a noise generating fan assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an illustrative representation of the mechanical fan assembly of the present invention in a working state, including its general appearance and its ability to generate noise with minimal air flow emanating therefrom.

FIG. 2 shows a front view of an embodiment of the flat fan blade assembly of the present invention.

FIG. 3 shows front and side views of an embodiment of the flat fan blade of the present invention.

FIG. 4 shows a front view of an embodiment of the perforated fan blade assembly of the present invention.

FIG. 5 shows front and side views of an embodiment of the perforated fan blade of the present invention.

FIG. 6 shows an illustrative embodiment of the fan blade hub imbalance with respect to the electric motor driving the fan blade assembly.

FIG. 7 shows a view of the oscillatory motion of the fan blade hub during operation.

FIG. 8 shows an embodiment of the fan blade of the present invention, in which the fan blade base includes a removable attachment.

FIG. 9 shows another embodiment of the fan blade of the present invention, in which the fan blade base includes a removable attachment.

FIG. 10 shows a view of the noise generating fan assembly of the present invention, wherein the fan shroud is removable to gain access to the fan hub for operable replacement of the fan blades thereon.

### DETAILED DESCRIPTION OF THE INVENTION

Reference is made herein to the attached drawings. Like reference numerals are used throughout the drawings to depict like or similar elements of the noise generating fan assembly. For the purposes of presenting a brief and clear description of the present invention, the preferred embodiment will be discussed as used for generating noise for a sleeping user while operably determining air flow therefrom. The figures are intended for representative purposes only and should not be considered to be limiting in any respect.

Referring now to FIG. 1, there is shown an illustrative embodiment of the noise generating fan assembly of the present invention. The fan assembly is one that is adapted to provide a constant level of ambient noise for a sleeping user, while offer an operatively adjustable air flow means. In this way, the user can enjoy the soothing sounds of a mechanical fan while sleeping and control the air movement generated therefrom during the different seasons of the year. In colder months or in colder climates, the fan can be adjusted to produce a low volume of air movement while retaining a high level of mechanical fan noise. Likewise a non-adjustable embodiment is contemplated that is purchased as a static assembly having a given air flow capacity and noise generation capability. Several embodiments of both the adjustable and the static assembly are contemplated and herein disclosed.

In the illustrative embodiment of FIG. 1, the mechanical fan assembly comprises a fan housing 100 having a front portion 101 and a rear portion 105, an apertured front surface 102, an apertured rear surface, and an internal volume supporting a rotating fan blade assembly 108 therein. The fan housing 100 is supported by a stand 107 that may be adjustable and suited for tabletop use or elevated support above a floor surface. This fan configuration is well understood in the art of mechanical fans. The internal fan blade assembly 108 comprises a hub attached to a plurality of fan blades for creating a defined mechanical fan noise, which is driven by an electric motor whose speed is dictated by the user via an input switch 107 or button on the fan housing 100.

The mechanical fan of the present invention is contemplated first as a noise generator and second as an air flow means. The fan blades of the fan blade assembly 108 are adapted to create a desired level of ambient noise, measured in sound pressure level, while the air flow generated by the fan blades is such that the fan can be operated without creating increasing air movement within a room and thus chilling a user while creating the accustomed fan noise. Several different fan blades are disclosed, whereby air is drawn 104 through the rear portion 105 of the fan housing 100 and over the blades assembly 108 and forced through the apertured surface 102 of the fan front portion 101. The velocity and thus mass flow rate of the outgoing air 103 is dictated by the efficiency of the fan blades within the housing 100, which is determined by the user prior to purchase of the assembly or is operably controlled by selecting a desired fan baled assembly for the given season. The fan blade assembly, if replaceable, is replaced by removing the front portion 101 of the fan housing 100 when the assembly is not in operation.

Referring now to FIGS. 2 and 3, there are shown several views of one contemplated embodiment of the fan blade assembly 108 and the fan blades 11 thereon. In this embodiment, the fan blades 11 are comprised of flat forward 13 and rear 14 surfaces, along with a thin-walled construction. The curvature naturally given to most efficient mechanical fan blades is replaced with a flat configuration that generates fan noise as it travels through the air, but is inefficient at moving air while in motion. This in turn provides a mechanical fan noise without the associated air movement for those in colder environments not wishing to be chilled. The fan blades 11 attach to a central fan hub 12, where the fans may be position slightly out of plane from one another or aligned in a common plane, as the design will dictate.

Referring now to FIGS. 4, and 5, there are shown views of a second contemplated embodiment of the fan blade assembly 108. This embodiment contemplates a fan blade assembly having apertured fan blades 21. The fan blades 21 comprise apertures 22 thereon that reduce the material surface 28 of the fan blade, whereby the fan blades 21 produce noise and reduced air flow. Similar to the first embodiment, this apertured embodiment may include planar forward 23 and rear 24 surfaces that may be aligned on the fan blade hub 12 or positioned out of plane from one another.

Both the apertured embodiment and the flat blade embodiments of the fan blade assembly represent fan blades that create noise as they are drawn through the air by the mechanical fan electric motor, but have a minimized capacity to move air through the fan housing. The blades disperse air laterally or are simply inefficient at directing the air through the fan housing forward portion, thus the blade create noise as they move through the air but are largely ineffective at moving air over a sleeping user. This prevents chilling of the sleeping user in colder environments, while offering largely the same mechanical fan noise the user may be accustomed to with traditional fans.

Referring now to FIG. 6, there is shown an embodiment of the connection between the fan electric motor and the fan hub 12 of the fan blade assembly. The contemplated connection between the fan electric motor and the fan hub 12 is one that is imbalanced or counter balanced. The electric motor drive shaft 43 connects to the fan hub 12 off center from its central axis 42. A counterweight 41 is provided along an opposite side of the drive shaft 41 such that the fan hub oscillates during its rotational movement about the electric motor.

Referring now to FIG. 7, there is shown a view of the path of the fan hub 12 about its central axis. The oscillation of the fan hub 12 increases the noise generation of the assembly, while the fan housing is supported in a stable configuration to remove any vibration into the support surface. The noise generated is strictly from the operation of the electric motor, the fan blades moving through the air, and the oscillation of the fan blade hub through it oscillatory motion.

Referring now to FIG. 8, there is shown yet another embodiment of the fan blade 11 of the present invention. In this embodiment, the flat blade 11 includes a removable base 50 that is adapted to achieve a removable connection with the fan hub of the fan blade assembly. Removably attaching the fan blades allows the user to change the air flow capacity of the mechanical fan throughout the year and place more traditional, curved blades thereon in warmer months. The removable base 50 comprises a threaded member 51 that threadably attaches to an aperture in the fan hub.

Referring now to FIG. 9, there is shown yet another embodiment of the fan blade 61 of the present invention. In this embodiment, the fan blade 61 comprises an elongated member having a cylindrical or similar shape and a narrow planform area for displacing air as it moves therethrough. This embodiment may be permanently attached to the fan hub or removably attached via the threaded removable base. This embodiment 61 provides for nearly no air movement, while providing a fan noise via the electric motor, oscillating fan hub, and the member 62 movement through the air.

Referring now to FIG. 10, there is shown a frontal view of the fan assembly housing 100 wherein the front portion thereof is removed to allow the user to gain access to the fan blade hub 12. Once access is achieved, the fan blades 11 can be replaced thereon via the removable attachment 51 at the base of each fan blade 11. The removable attachment 51 is a threaded member that secures within threaded apertures 55 in the blade hub 12. In this way, the user can replace the fan blades as desired to suit the air movement needs thereof while sleeping.

Many individuals require background or white noise to assist with falling asleep. Conventional solutions include the use of a fan to create background noise above ambient noise; however, such solutions are impractical in the winter months when fan use would increase air flow and chill a room. To prevent such occurrences, individuals may turn down the speed of the fan, which causes a reduction in noise. Alternative solutions include the use of white noise generators. These devices, however, often require the use of headphones, which may be difficult to retain on the head while sleeping.

The present invention describes a noise generating fan assembly that offers operably reduced air flow with traditional levels of mechanical fan noise. The assembly comprises a mechanical fan having sets of interchangeable blades, wherein the blades have different levels of efficiency with regard to air movement. The connection between the fan hub and the fan electric motor is imbalanced to oscillate the fan hub during its rotation about the motor. This helps increases noise generation and improves the soothing fan noise desired by a sleeping user.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A noise generating fan assembly, comprising:
a fan housing having a front portion, a rear portion, and an interior, said fan housing supported by a stand;
an electric motor connected to a fan blade assembly within said fan housing interior;
said fan blade assembly comprising a fan hub and a plurality of fan blades extending therefrom;
said fan blades comprising a planar forward surface and a planar rear surface;
said fan blades adapted to create noise during rotation of said electric motor with minimal air flow through said fan housing front portion.

2) The noise generating fan assembly of claim 1, wherein said fan blades further comprise a plurality of apertures therethrough.

3) The noise generating fan assembly of claim 1, wherein said electric motor connects to said fan hub off-center therefrom to establish an imbalance.

4) The noise generating fan assembly of claim 3, wherein further comprising a counter weight on said fan hub.

5) The noise generating fan assembly of claim 1, wherein:
said fan blades are removably attached to said fan hub;
said front portion of said fan housing is removably attached.

6) A noise generating fan assembly, comprising:
a fan housing having a front portion, a rear portion, and an interior, said fan housing supported by a stand;
an electric motor connected to a fan blade assembly within said fan housing interior;
said fan blade assembly comprising a fan hub and a plurality of fan blades extending therefrom;
said fan blades comprising elongated members having a narrow planform area;
said fan blades adapted to create noise during rotation of said electric motor with minimal air flow through said fan housing front portion.

7) The noise generating fan assembly of claim 6, wherein said elongated members further comprise cylindrical members.

8) The noise generating fan assembly of claim 6, wherein said electric motor connects to said fan hub off-center therefrom to establish an imbalance.

9) The noise generating fan assembly of claim 8, wherein further comprising a counter weight on said fan hub.

10) The noise generating fan assembly of claim 6, wherein:
said fan blades are removably attached to said fan hub;
said front portion of said fan housing is removably attached.
